(19) United States
(12) Patent Application Publication
(10) Pub. No.: US 2007/0132965 A1
(43) Pub. Date: Jun. 14, 2007

(54) System and method for displaying an image

(76) Inventors: Niranjan Damera-Venkata, Palo Alto, CA (US); Nelson Liang An Chang, Palo Alto, CA (US); Simon Widdowson, Palo Alto, CA (US); William J. Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/301,060

(22) Filed: Dec. 12, 2005

(51) Int. Cl. G03B 21/26

(52) U.S. Cl. 353/94

(57) ABSTRACT

A method of displaying an image with a display system includes receiving image data for the image. A plurality of sub-frames corresponding to the image data are generated based on a geometric relationship between a reference coordinate system and a plurality of projectors. The plurality of sub-frames are projected onto a target surface with the plurality of projectors, thereby producing a resulting image on the target surface. The resulting image includes small pixels overlapping with large pixels over a substantial portion of the resulting image.

### CROSS-REFERENCE TO RELATED APPLICATION

This application is related to U.S. patent application Ser. No. 11/080,223, filed Mar. 15, 2005, and entitled PROJECTION OF OVERLAPPING SINGLE COLOR SUB-FRAMES ONTO A SURFACE and U.S. patent application Ser. No. 11/080,583, filed Mar. 15, 2005, and entitled PROJECTION OF OVERLAPPING SUB-FRAMES ONTO A SURFACE, both of which are hereby incorporated by reference herein.

### BACKGROUND

Two types of projection display systems are digital light processor (DLP) systems, and liquid crystal display (LCD) systems. It is desirable in some projection applications to provide a high lumen level output, but it is very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed systems do not generate optimal sub-frames in real-time, and do not take into account arbitrary relative geometric distortion between the component projectors.

Existing projection systems do not provide a cost effective solution for high lumen level (e.g., greater than about 10,000 lumens) applications. Existing projection systems also typically use a single resolution or scale for projected images, and for tiled projection, these systems typically use ad-hoc blending techniques. In addition, existing multi-projector systems do not typically produce images that accurately reproduce the color of the original image data.

### SUMMARY

One form of the present invention provides a method of displaying an image with a display system. The method includes receiving image data for the image. A plurality of sub-frames corresponding to the image data are generated based on a geometric relationship between a reference coordinate system and a plurality of projectors. The plurality of sub-frames are projected onto a target surface with the plurality of projectors, thereby producing a resulting image on the target surface. The resulting image includes small pixels overlapping with large pixels over a substantial portion of the resulting image.

### BRIEF DESCRIPTION OF THE DRAWINGS

FIG. 1 is a block diagram illustrating an image display system according to one embodiment of the present invention.

FIGS. 2A-2C are schematic diagrams illustrating the projection of two sub-frames according to one embodiment of the present invention.

FIG. 3 is a diagram illustrating a model of an image formation process according to one embodiment of the present invention.

FIG. 4 is a diagram illustrating multi-resolution imaging arrays of two projectors in the display system shown in FIG. 1 according to one embodiment of the present invention.

FIG. 5 is a diagram illustrating the distortion of sub-frames projected by projectors in the display system shown in FIG. 1 to produce multiple pixel sizes according to one embodiment of the present invention.

FIG. 6 is a diagram illustrating a combination of tiled and superimposed projection according to one embodiment of the present invention.

FIG. 7 is a flow diagram illustrating a method of displaying an image with a display system according to one embodiment of the present invention.

FIG. 8 is a diagram illustrating a method for generating sub-frames that, when projected onto a target surface, produce an image that accurately reproduces the color of a given desired high-resolution image, according to one embodiment of the present invention.

FIG. 9 is a flow diagram illustrating a method of displaying an image with display system according to another embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

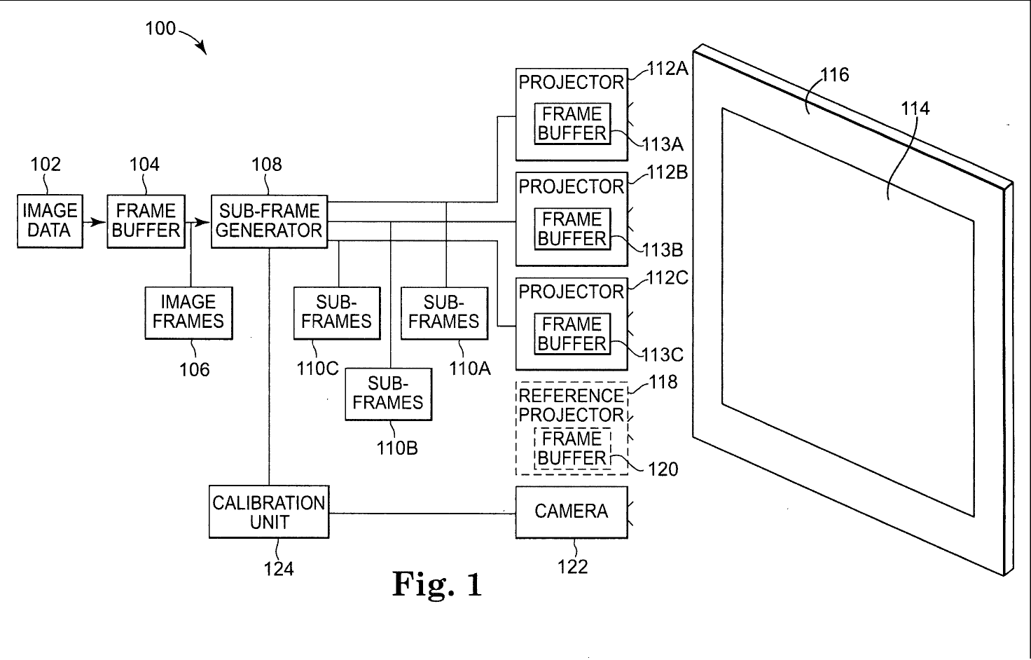

FIG. 1 is a block diagram illustrating an image display system 100 according to one embodiment of the present invention. Image display system 100 processes image data 102 and generates a corresponding displayed image 114. Displayed image 114 is defined to include any pictorial, graphical, or textural characters, symbols, illustrations, or other representations of information.

In one embodiment, image display system 100 includes image frame buffer 104, sub-frame generator 108, projectors 112A-112C (collectively referred to as projectors 112), camera 122, and calibration unit 124. Image frame buffer 104 receives and buffers image data 102 to create image frames 106. Sub-frame generator 108 processes image frames 106 to define corresponding image sub-frames 110A-110C (collectively referred to as sub-frames 110). In one embodiment, for each image frame 106, sub-frame generator 108 generates one sub-frame 110A for projector 112A, one sub-frame 110B for projector 112B, and one sub-frame 110C for projector 112C. The sub-frames 110A-110C are received by projectors 112A-112C, respectively, and stored in image frame buffers 113A-113C (collectively referred to as image frame buffers 113), respectively. Projectors 112A-112C project the sub-frames 110A-110C, respectively, onto target surface 116 to produce displayed image 114 for viewing by a user.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

Projectors 112 receive image sub-frames 110 from sub-frame generator 108 and, in one embodiment, simultaneously project the image sub-frames 110 onto target surface 116 at overlapping and spatially offset positions to produce displayed image 114. In one embodiment, display system 100 is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves).

A problem of sub-frame generation, which is addressed by embodiments of the present invention, is to determine appropriate values for the sub-frames 110 so that the resulting displayed image 114 produced by the projected sub-frames 110 is close in appearance to how the high-resolution image (e.g., image frame 106) from which the sub-frames 110 were derived would appear if displayed directly.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

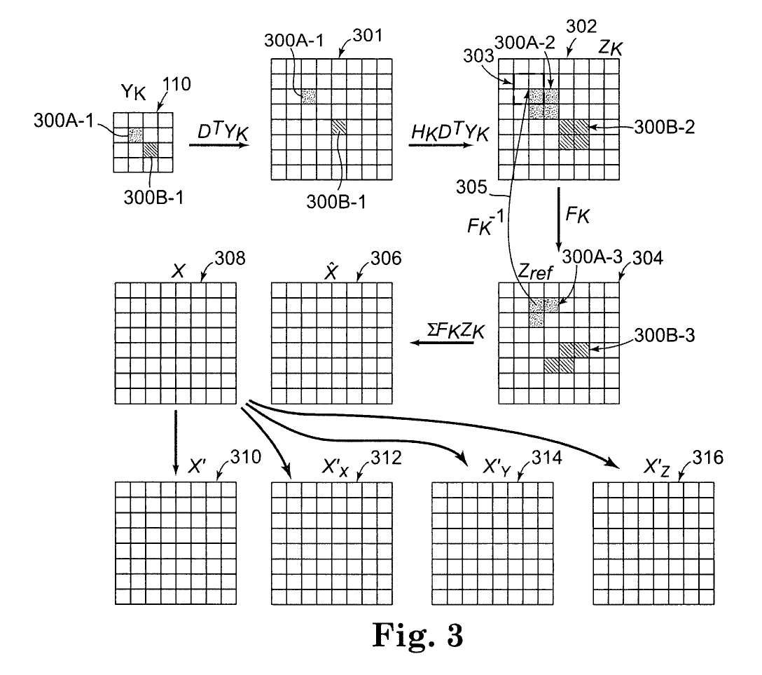

Also shown in FIG. 1 is reference projector 118 with an image frame buffer 120. Reference projector 118 is shown with hidden lines in FIG. 1 because, in one embodiment, projector 118 is not an actual projector, but rather is a hypothetical high-resolution reference projector that is used in an image formation model for generating optimal sub-frames 110, as described in further detail below with reference to FIG. 3. In one embodiment, the location of one of the actual projectors 112 is defined to be the location of the reference projector 118.

In one embodiment, display system 100 includes a camera 122 and a calibration unit 124, which are used in one form of the invention to automatically determine a geometric mapping between each projector 112 and the reference projector 118, as described in further detail below with reference to FIG. 3.

In one form of the invention, image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environment.

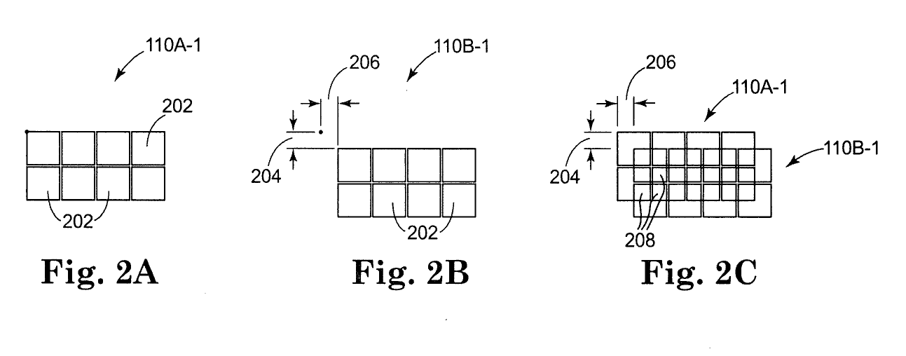

In one embodiment, display system 100 uses two projectors 112. FIGS. 2A-2C are schematic diagrams illustrating the projection of two sub-frames 110 according to one embodiment of the present invention. As illustrated in FIGS. 2A and 2B, sub-frame generator 108 defines two image sub-frames 110 for each of the image frames 106. More specifically, sub-frame generator 108 defines a first sub-frame 110A-1 and a second sub-frame 110B-1 for an image frame 106. As such, first sub-frame 110A-1 and second sub-frame 110B-1 each include a plurality of columns and a plurality of rows of individual pixels 202 of image data.

In one embodiment, as illustrated in FIG. 2B, when projected onto target 116, second sub-frame 110B-1 is offset from first sub-frame 110A-1 by a vertical distance 204 and a horizontal distance 206. As such, second sub-frame 110B-1 is spatially offset from first sub-frame 110A-1 by a predetermined distance. In one illustrative embodiment, vertical distance 204 and horizontal distance 206 are each approximately one-half of one pixel.

As illustrated in FIG. 2C, a first one of the projectors 112A projects first sub-frame 110A-1 in a first position and a second one of the projectors 112B projects second sub-frame 110B-1 in a second position, spatially offset from the first position. More specifically, the display of second sub-frame 110B-1 is spatially shifted relative to the display of first sub-frame 110A-1 by vertical distance 204 and horizontal distance 206. As such, pixels of first sub-frame 110A-1 overlap pixels of second sub-frame 110B-1, thereby producing the appearance of higher resolution pixels 208. The overlapped sub-frames 110A-1 and 110B-1 also produce a brighter overall image 114 than either of the sub-frames 110 alone. In other embodiments, more than two projectors 112 are used in system 100, and more than two sub-frames 110 are defined for each image frame 106, which results in a further increase in the resolution and brightness of the displayed image 114.

It will be understood by persons of ordinary skill in the art that the sub-frames 110 projected onto target 116 may have perspective distortions, and the pixels may not appear as perfect squares with no variation in the offsets and overlaps from pixel to pixel, such as that shown in FIGS. 2A-2C. Rather, in one form of the invention, the pixels of sub-frames 110 take the form of distorted quadrilaterals or other some other shape, and the overlaps may vary as a function of position. Thus, terms such as “spatially shifted” and “spatially offset positions” as used herein are not limited to a particular pixel shape or fixed offsets and overlaps from pixel to pixel, but rather are intended to include any arbitrary pixel shape, and offsets and overlaps that may vary from pixel to pixel.

In one form of the invention, sub-frames 110 have a lower resolution than image frames 106. Thus, sub-frames 110 are also referred to herein as low-resolution images or sub-frames 110, and image frames 106 are also referred to herein as high-resolution images or frames 106. It will be understood by persons of ordinary skill in the art that the terms low resolution and high resolution are used herein in a comparative fashion, and are not limited to any particular minimum or maximum number of pixels.

In one form of the invention, display system 100 produces a superimposed projected output that takes advantage of natural pixel mis-registration to provide a displayed image 114 with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to FIG. 3.

FIG. 3 is a diagram illustrating a model of an image formation process according to one embodiment of the present invention. The sub-frames 110 are represented in the model by Yₖ, where “k” is an index for identifying the individual projectors 112. Thus, Y₁, for example, corresponds to a sub-frame 110A for a first projector 112A, Y₂ corresponds to a sub-frame 110B for a second projector 112B, etc. Two of the sixteen pixels of the sub-frame 110 shown in FIG. 3 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Equation I
Zₖ=HₖD^{T}Yₖ
where:
k=index for identifying the projectors 112;
Zₖ=low-resolution sub-frame 110 of the kth projector 112 on a hypothetical high-resolution grid;
Hₖ=Interpolating filter for low-resolution sub-frame 110 from kth projector 112;
D^{T}=up-sampling matrix; and
Yₖ=low-resolution sub-frame 110 of the kth projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 3, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the k^{th} projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the k^{th} projector 112 to a reference coordinate system, such as the frame buffer 120 of the reference projector 118 (FIG. 1), with sub-pixel accuracy, to generate a warped image 304 (Z_{ref}). In one form of the invention, the transformation, Fₖ, is a coordinate mapping such as a translational shift, affine transformation, projective warp, or a more general non-linear transformation.

In one embodiment, Fₖ is linear with respect to pixel intensities, but is non-linear with respect to the coordinate transformations. As shown in FIG. 3, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one form of the present invention, during the forward mapping (Fₖ), the inverse mapping (Fₖ⁻¹) is also utilized as indicated at 305 in FIG. 3. Each destination pixel in image 304 is back projected (i.e., Fₖ⁻¹) to find the corresponding location in image 302. For the embodiment shown in FIG. 3, the location in image 302 corresponding to the upper-left pixel of the pixels 300A-3 in image 304 is the location at the upper-left corner of the group of pixels 300A-2. In one form of the invention, the values for the pixels neighboring the identified location in image 302 are combined (e.g., averaged) to form the value for the corresponding pixel in image 304. Thus, for the example shown in FIG. 3, the value for the upper-left pixel in the group of pixels 300A-3 in image 304 is determined by averaging the values for the four pixels within the frame 303 in image 302.

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (X-hat) in the reference projector frame buffer 120, as represented in the following Equation II:

$$\hat{X} = {\sum }_{k} {F}_{k} {Z}_{k} \qquad Equation II$$

where:
k=index for identifying the projectors 112;
X-hat=hypothetical or simulated high-resolution image 306 in the reference projector frame buffer 120;
Fₖ=operator that maps a low-resolution sub-frame 110 of the kth projector 112 on a hypothetical high-resolution grid to the reference projector frame buffer 120; and
Zₖ=low-resolution sub-frame 110 of kth projector 112 on a hypothetical high-resolution grid, as defined in Equation I.

If the simulated high-resolution image 306 (X-hat) in the reference projector frame buffer 120 is identical to a given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 1) received by sub-frame generator 108.

In one embodiment, the deviation of the simulated high-resolution image 306 (X-hat) from the desired high-resolution image 308 (X) is modeled as shown in the following Equation III:

Equation III
X=\hat{X}+η
where:
X=desired high-resolution frame 308;
X-hat=hypothetical or simulated high-resolution frame 306 in the reference projector frame buffer 120; and

η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation IV:

$${Y}_{k}^{*} = {arg max}_{{Y}_{k}} P ( \hat{X} \vert X ) \qquad Equation IV$$

where:
k=index for identifying the projectors 112;
Yₖ*=optimum low-resolution sub-frame 110 of the kth projector 112;
Yₖ=low-resolution sub-frame 110 of the kth projector 112;
X-hat=hypothetical or simulated high-resolution frame 306 in the reference projector frame buffer 120, as defined in Equation II;

X=desired high-resolution frame 308; and
P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 (FIG. 1) determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
X-hat=hypothetical or simulated high-resolution frame 306 in the reference projector frame buffer 120, as defined in Equation II;
X=desired high-resolution frame 308;
P(X-hat|X)=probability of X-hat given X;
P(X|X-hat)=probability of X given X-hat;
P(X-hat)=prior probability of X-hat; and
P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {ⅇ}^{- \frac{{‖ X - \hat{X} ‖}^{2}}{2 {σ}^{2}}} \qquad Equation VI$$

where:
X-hat=hypothetical or simulated high-resolution frame 306 in the reference projector frame buffer 120, as defined in Equation II;
X=desired high-resolution frame 308;
P(X|X-hat)=probability of X given X-hat;
C=normalization constant; and

σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {ⅇ}^{- \{ {β}^{2} ( {‖ ∇ \hat{X} ‖}^{2} ) \}} \qquad Equation VII$$

where:
P(X-hat)=prior probability of X-hat;
β=smoothing constant;
Z(β)=normalization function;
∇=gradient operator; and
X-hat=hypothetical or simulated high-resolution frame 306 in the reference projector frame buffer 120, as defined in Equation II.

In another embodiment of the invention, the smoothness requirement is based on a prior Laplacian model, and is expressed in terms of a probability distribution for X-hat given by the following Equation VIII:

$$P ( \hat{X} ) = \frac{1}{Z ( β )} {ⅇ}^{- \{ β ( ‖ ∇ \hat{X} ‖ ) \}} \qquad Equation VIII$$

where:
P(X-hat)=prior probability of X-hat;
β=smoothing constant;
Z(β)=normalization function;
∇=gradient operator; and
X-hat=hypothetical or simulated high-resolution frame 306 in the reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {arg min}_{{Y}_{k}} {‖ X - \hat{X} ‖}^{2} + {β}^{2} {‖ ∇ \hat{X} ‖}^{2} \qquad Equation IX$$

where:
k=index for identifying the projectors 112;
Yₖ*=optimum low-resolution sub-frame 110 of the kth projector 112;
Yₖ=low-resolution sub-frame 110 of the kth projector 112;
X-hat=hypothetical or simulated high-resolution frame 306 in the reference projector frame buffer 120, as defined in Equation II;
X=desired high-resolution frame 308;
β=smoothing constant; and
∇=gradient operator.

The function minimization problem given in Equation IX is solved by substituting the definition of X-hat from Equation II into Equation IX and taking the derivative with respect to Yₖ, which results in an iterative algorithm given by the following Equation X:

Equation X
Yₖ⁽ⁿ⁺¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾┘}
where:
k=index for identifying the projectors 112;
n=index for identifying iterations;
Yₖ⁽ⁿ⁺¹⁾=low-resolution sub-frame 110 for the kth projector 112 for iteration number n+1;
Yₖ⁽ⁿ⁾=low-resolution sub-frame 110 for the kth projector 112 for iteration number n;
Θ=momentum parameter indicating the fraction of error to be incorporated at each iteration;
D=down-sampling matrix;
Hₖ^{T}=Transpose of interpolating filter, Hₖ, from Equation I (in the image domain, Hₖ^{T} is a flipped version of Hₖ);
Fₖ^{T}=Transpose of operator, Fₖ, from Equation II (in the image domain, Fₖ^{T} is the inverse of the warp denoted by Fₖ);
X-hat⁽ⁿ⁾=hypothetical or simulated high-resolution frame 306 in the reference projector frame buffer 120, as defined in Equation II, for iteration number n;
X=desired high-resolution frame 308;
β=smoothing constant; and
∇²=Laplacian operator.

Equation X may be intuitively understood as an iterative process of computing an error in the reference projector 118 coordinate system and projecting it back onto the sub-frame data. In one embodiment, sub-frame generator 108 (FIG. 1) is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for the sub-frames 110 is determined. In one embodiment, the initial guess for the sub-frames 110 is determined by texture mapping the desired high-resolution frame 308 onto the sub-frames 110. In one form of the invention, the initial guess is determined from the following Equation XI:

Equation XI
Yₖ⁽⁰⁾=DIₖFₖ^{T}X
where:
k=index for identifying the projectors 112;
Yₖ⁽⁰⁾=initial guess at the sub-frame data for the sub-frame 110 for the kth projector 112;
D=down-sampling matrix;
Iₖ=interpolation filter;
Fₖ^{T}=Transpose of operator, Fₖ, from Equation II (in the image domain, Fₖ^{T} is the inverse of the warp denoted by Fₖ); and
X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Iₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Iₖ).

In another form of the invention, the initial guess, Yₖ⁽⁰⁾, for the sub-frames 110 is determined from the following Equation XII

Equation XII
Yₖ⁽⁰⁾=DFₖ^{T}X
where:
k=index for identifying the projectors 112;
Yₖ⁽⁰⁾=initial guess at the sub-frame data for the sub-frame 110 for the kth projector 112;
D=down-sampling matrix;
Fₖ^{T}=Transpose of operator, Fₖ, from Equation II (in the image domain, Fₖ^{T} is the inverse of the warp denoted by Fₖ); and
X=desired high-resolution frame 308.

Equation XII is the same as Equation XI, except that the interpolation filter (Iₖ) is not used.

Several techniques are available to determine the geometric mapping (Fₖ) between each projector 112 and the reference projector 118, including manually establishing the mappings, or using camera 122 and calibration unit 124 (FIG. 1) to automatically determine the mappings. Techniques for determining geometric mappings that are suitable for use in one form of the present invention are described in U.S. patent application Ser. No. 10/356,858, filed Feb. 3, 2003, entitled “MULTIFRAME CORRESPONDENCE ESTIMATION”, and U.S. patent application Ser. No. 11/068,195, filed Feb. 28, 2005, entitled “MULTI-PROJECTOR GEOMETRIC CALIBRATION”, both of which are hereby incorporated by reference herein.

In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a display system 100 with two projectors 112A and 112B, assuming the first projector 112A is the reference projector 118, the geometric mapping of the second projector 112B to the first (reference) projector 112A can be determined as shown in the following Equation XIII:

Equation XIII
F₂=T₂T₁⁻¹
where:
F₂=operator that maps a low-resolution sub-frame 110 of the second projector 112B to the first (reference) projector 112A;
T₁=geometric mapping between the first projector 112A and the camera 122; and
T₂=geometric mapping between the second projector 112B and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

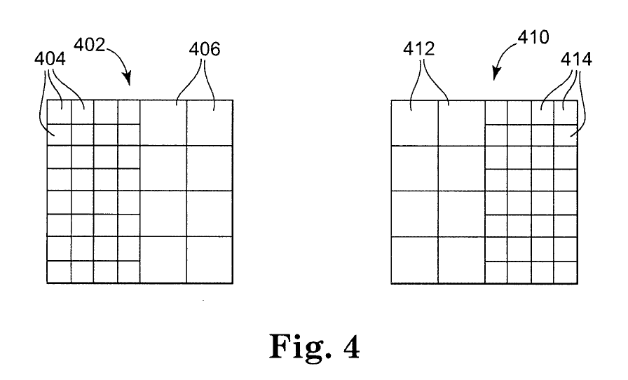

In one form of the invention, multi-projector display system 100 is a multi-resolution system, where the displayed image 114 is formed by approximating the original desired image 308 at more than one scale (resolution), and by manipulating pixel sizes on the target surface 116 to provide multiple pixel sizes or resolutions. In one embodiment, both a coarse resolution and a fine resolution are present in the projected image 114 at the same time and at the same location (i.e., the coarse scale and fine scale are superimposed). A multi-resolution grid is used to directly construct the best approximation of the original image 308 by optimally determining what sub-frames 110 each component projector 112 should render. The signal approximation at multiple scales provides a much better representation of fine detail than superimposed projection alone. Smaller pixel sizes provide the fine details or the small scale, and the larger pixel sizes provide the coarse detail or the large scale. FIGS. 4-6, which are described below, illustrate three embodiments for implementing a multi-resolution display system 100.

FIG. 4 is a diagram illustrating multi-resolution imaging arrays 402 and 410 of two projectors 112 in display system 100 according to one embodiment of the present invention. In one embodiment, projectors 112 each include an imaging array, such as a discrete micro-mirror device (DMD) array, with pixels of varying size. In the embodiment shown in FIG. 4, a first imaging array 402 of a first projector 112A includes a set of high-resolution pixels 404 having a small pixel size, and a set of low-resolution pixels 406 having a large pixel size. A second imaging array 410 of a second projector 112B includes a set of low-resolution pixels 412 having a large pixel size, and a set of high-resolution pixels 414 having a small pixel size.

The positions of the small pixels 414 and the large pixels 412 of the second imaging array 410 are reversed, or in complimentary positions, from the positions of these pixels in the second imaging array 402. Thus, when the imaging arrays 402 and 410 are configured to project superimposed images, the small pixels 404 of the first imaging array 402 will overlap the large pixels 412 of the second imaging array 410, and the large pixels 406 of the first imaging array 402 will overlap the small pixels 414 of the second imaging array 410. In one embodiment, the projectors 112 with imaging arrays 402 and 410 are configured to produce a displayed image 114 with small high-resolution pixels that overlap large low-resolution pixels over a substantial portion (e.g., greater than twenty percent) of the image 114.

In the embodiment illustrated in FIG. 4, each of the large pixels 406 and 412 is four-times larger than the small pixels 404 and 414. It should be noted that the terms “small” pixels and “large” pixels are used in a comparative fashion, and are not limited to any particular size. In another embodiment, imaging arrays 402 and 410 each include more than two pixel sizes.

In one embodiment, the sub-frames that are projected using imaging arrays 402 and 410 will appear similar to the imaging arrays 402 and 410 themselves, with both small high-resolution pixels and large low-resolution pixels. In another embodiment, the high-resolution pixels 404 and 414 of the imaging arrays 402 and 410 are arranged in 2×2 blocks of pixels, for example, and each block acts as a single low resolution pixel (i.e., the content for a given high resolution pixel in the block is repeated for all four pixels in the block). Thus, the size of the pixels in imaging arrays 402 and 410 does not necessarily correspond to resolution in the projected sub-frames.

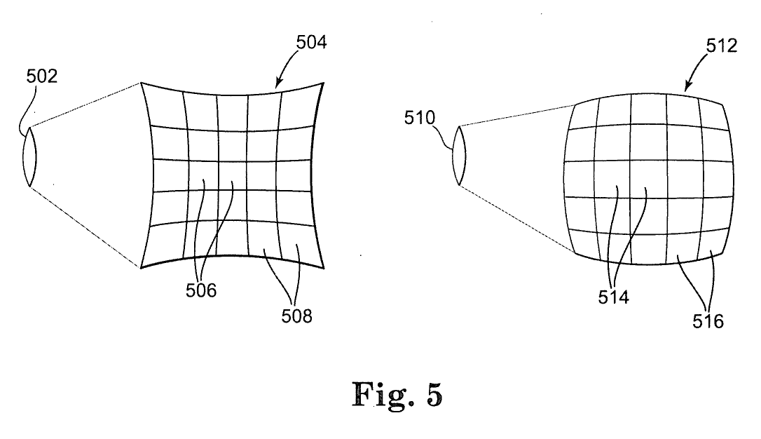

FIG. 5 is a diagram illustrating the distortion of sub-frames projected by projectors 112 in display system 100 to produce multiple pixel sizes according to one embodiment of the present invention. In one embodiment, projectors 112 each include optics, such as anamorphic lenses, that distort projected sub-frames so that the pixel sizes are smaller in one area and larger in another area of the projected sub-frames. In the embodiment shown in FIG. 5, optics 502 of a first projector 112A produce a projected sub-frame 504 with pin cushion distortion. The projected sub-frame 504 with pin cushion distortion has smaller high-resolution pixels 506 near the center of the sub-frame 504, and larger low-resolution pixels 508 near the edges of the sub-frame 504. Optics 510 of a second projector 112B produce a projected sub-frame 512 with barrel distortion. The projected sub-frame 512 with barrel distortion has larger low-resolution pixels 514 near the center of the sub-frame 512, and smaller high-resolution pixels 516 near the edges of the sub-frame 512.

When the sub-frames 504 and 512 are projected in a superimposed manner, the small high-resolution pixels 506 of the sub-frame 504 will overlap the large low-resolution pixels 514 of the sub-frame 512, and the large low-resolution pixels 508 of the sub-frame 504 will overlap the small high-resolution pixels 516 of the sub-frame 512. In one embodiment, the projectors 112 with optics 502 and 510 are configured to produce a displayed image 114 with small high-resolution pixels that overlap large low-resolution pixels over a substantial portion of the image 114.

In another form of the invention, at least one of the projectors 112 includes optics to focus light onto small spots, and thereby produce projected sub-frames with dark spaces or gaps between each pixel. These dark spaces or gaps are then “filled in” by overlapping sub-frames projected by other projectors 112.

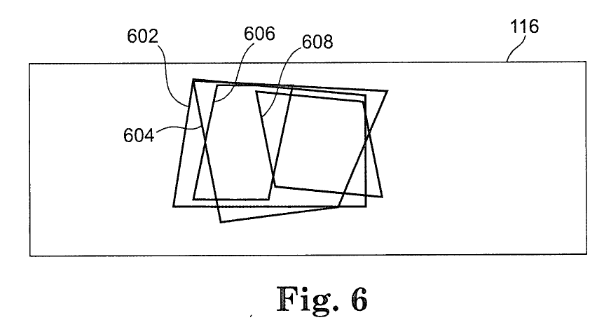

FIG. 6 is a diagram illustrating a combination of tiled and superimposed projection according to one embodiment of the present invention. Four projected sub-frames 602, 604, 606, and 608 on target surface 116 are shown in FIG. 6. A first sub-frame 606 projected by a first projector 112 and a second sub-frame 608 projected by a second projector 112 are tiled sub-frames, and overlap slightly near the edges of these sub-frames. A third sub-frame 602 projected by a third projector 112 and a fourth sub-frame 604 projected by a fourth projector 112 are superimposed sub-frames, and substantially overlap each other and the tiled sub-frames 606 and 608. In one form of the invention, two projected sub-frames are defined to be tiled sub-frames if the area of any overlapping portion is less than about twenty percent of the total area of one of the projected sub-frames on the target surface 116, and two projected sub-frames are defined to be superimposed sub-frames if the area of the overlapping portion is eighty percent or more of the total area of one of the projected sub-frames on the target surface 116.

In one embodiment, the tiled sub-frames 606 and 608 are smaller and have smaller pixels and a higher resolution than the superimposed sub-frames 602 and 604, and provide a fine scale or resolution, and the larger superimposed sub-frames 602 and 604 with the larger pixels and lower resolution provide a coarse scale or resolution. Unlike solutions that are exclusively tiled, the coarse scale of the superimposed sub-frames 602 and 604 helps to hide seams and compensate for color and luminance changes across projectors 112. In one embodiment, projectors 112 are configured to simultaneously project a combination of tiled and superimposed sub-frames, such as sub-frames 602, 604, 606, and 608, and thereby produce a displayed image 114 with small high-resolution pixels that overlap large low-resolution pixels over a substantial portion of the image 114.

In one form of the invention, given any configuration of projectors 112, including any combination of tiled and superimposed projectors 112, sub-frame generator 108 is configured to generate sub-frames 110 for the given configuration that, when projected through each projector 112, produce the best approximation of a given input image 308. In one embodiment, sub-frame generator 108 is configured to generate the sub-frames 110 based on mapping functions that characterize how pixels from any projector 112 map onto a reference coordinate system, such as that of the reference projector 118, and based on the relative spatially varying luminance and color contributions of each projector 112.

Taking into account the relative luminance contribution of each projector 112 is important in one embodiment of the invention. For example, in a combined tiled and superimposed projector configuration, such as that shown in FIG. 6 and described above, the tiled sub-frames 606 and 608 will appear much brighter since the light for these sub-frames is concentrated onto a smaller area. In one embodiment, the relative spatially varying luminance profile for each projector 112 is incorporated into the image formation model that is used in generating sub-frames 110. Color characteristics of each projector 112 are also included in the model in one embodiment, as described below.

In one embodiment, the luminance profile, Lₖ, for each projector 112 is incorporated into a multi-projector image formation model as shown by the definition of the simulated high-resolution image 306 (X-hat) given in the following Equation XIV:

$$\hat{X} = {\sum }_{k} {F}_{k} {H}_{k} {D}^{T} \{ {L}_{k} {Y}_{k} + {B}_{k} \} + A \qquad Equation XIV$$

where:
k=index for identifying the projectors 112;
X-hat=hypothetical or simulated high-resolution image 306 in the reference projector frame buffer 120;
Fₖ=operator that maps a low-resolution sub-frame 110 of the kth projector 112 on a hypothetical high-resolution grid to the reference projector frame buffer 120;
Hₖ=interpolating filter for low-resolution sub-frame 110 from kth projector 112;
D^{T}=up-sampling matrix;
Lₖ=spatial luminance profile of the kth projector 112;
Yₖ=low-resolution sub-frame 110 of the kth projector 112;
Bₖ=dark level of the kth projector 112; and
A=ambient light

In one embodiment, the dark level, Bₖ, of each projector 112 in Equation XIV is determined by providing a series of all zeros or all black values to a selected one of the projectors 112 and measuring the selected projector's output luminance, such as by capturing the output of the projector with the camera 122. In one embodiment, the luminance profile, Lₖ, of each projector 112 in Equation XIV is determined by providing a series of known input values (e.g., all ones or all white) to a selected one of the projectors 112 and measuring the selected projector's output luminance, such as by capturing the output of the projector with the camera 122. In one embodiment, a luminance profile, Lₖ, is determined for each projector using the techniques described in U.S. patent application Ser. No. 11/258,624, filed on Oct. 26, 2005, and entitled LUMINANCE BASED MULTIPLE PROJECTOR SYSTEM, which is hereby incorporated by reference herein.

By using Equation XIV and applying the optimization techniques described above with respect to Equations III through X, and ignoring the ambient light contribution, A, in Equation XIV, the iterative sub-frame generation algorithm given by the following Equation XV is obtained:

Equation XV
Yₖ⁽ⁿ⁺¹⁾=Yₖ⁽ⁿ⁾−Θ{Lₖ^{T}DHₖ^{T}Fₖ^{T}└(\hat{X}⁽ⁿ⁾−X′)+β²∇²\hat{X}⁽ⁿ⁾┘}
where:
k=index for identifying the projectors 112;
n=index for identifying iterations;
Yₖ⁽ⁿ⁺¹⁾=low-resolution sub-frame 110 for the kth projector 112 for iteration number n+1;
Yₖ⁽ⁿ⁾=low-resolution sub-frame 110 for the kth projector 112 for iteration number n;
Θ=momentum parameter indicating the fraction of error to be incorporated at each iteration;
L^{T}ₖ=transpose of the spatial luminance profile, Lₖ, given in Equation XIV for the kth projector 112;
D=down-sampling matrix;
Hₖ^{T}=transpose of interpolating filter, Hₖ, from Equation XIV (in the image domain, Hₖ^{T} is a flipped version of Hₖ);
Fₖ^{T}=Transpose of operator, Fₖ, from Equation XIV (in the image domain, Fₖ^{T} is the inverse of the warp denoted by Fₖ);
X-hat⁽ⁿ⁾=hypothetical or simulated high-resolution frame 306 in the reference projector frame buffer 120, as defined in Equation XIV, for iteration number n;
X′=target luminance profile;

β=smoothing constant; and

∇²=Laplacian operator.

In one embodiment, sub-frame generator 108 generates initial guess sub-frames 110 for use in the iterative algorithm defined by Equation XV based on Equation XI or XII above. The pixels of sub-frames Yₖ in Equation XV comprise luminance values. Equation XV differs from Equation X in a couple of respects. First, Equation XV incorporates the luminance profile, Lₖ, of each projector 112. Second, the sub-frames, Yₖ, in Equation X are defined with respect to a desired high-resolution frame 308 (X), whereas the sub-frames, Yₖ, in Equation XV are defined with respect to a target luminance profile 310 (X′), which is shown in FIG. 3 and described in further detail below.

In one embodiment, the target luminance profile 310 (X′), in Equation XV is a smooth fit to the range of allowable luminance levels, and includes only those luminance levels that are achievable at any given location. The achievable luminance level at any given point on target surface 116 will depend on the number of projectors covering that point. For example, if two projectors 112 project sub-frames 110 that overlap by a small amount on the target surface 116, the maximum achievable luminance levels in the region of overlap will be much higher than those areas covered by only a single projector 112.

The target luminance profile 310 (X′) is generated in one embodiment by mapping values of a given high-resolution frame 308 (X) to target luminance values that lie within a range of spatially varying minimum and maximum achievable luminance values. In one form of the invention, projectors 112 all project sub-frames 110 that substantially overlap each other on target surface 116, and the target luminance profile 310 (X′) in Equation XV is calculated for this configuration from the desired high-resolution frame 308 (X) using the following Equation XVI:

Equation XVI
X′=\hat{X}ₘᵢₙ+X(\hat{X}ₘₐₓ−\hat{X}ₘᵢₙ)
where:
X′=target luminance profile 310;
X-hatₘᵢₙ=minimum value of X-hat in Equation XIV;
X-hatₘₐₓ=maximum value of X-hat in Equation XIV; and
X=desired high-resolution frame 308.

In the embodiment represented by Equation XVI, the target luminance profile 310 (X′) is generated by linearly scaling the pixel values of a given high-resolution frame 308 (X) to target values that lie within a range of minimum and maximum achievable luminance values. In one embodiment, X-hatₘᵢₙ in Equation XVI is determined by using Yₖ=0 in Equation XIV, and solving for X-hat, which will give the minimum values of X-hat (i.e., the minimum achievable luminance values at various points of the target surface 116). X-hatₘₐₓ in Equation XVI is determined by using Yₖ=1 in Equation XIV, and solving for X-hat, which will give the maximum values of X-hat (i.e., the maximum achievable luminance values at various points of the target surface 116). In another embodiment, the minimum and maximum achievable luminance values for a given projector configuration may be obtained by projecting all zeros (i.e., black) and all ones (i.e., white) with the projectors 112, and then capturing an image of the resulting projected images 114 with camera 122. The captured images give the spatially varying range of luminance values that are possible for the given projector configuration.

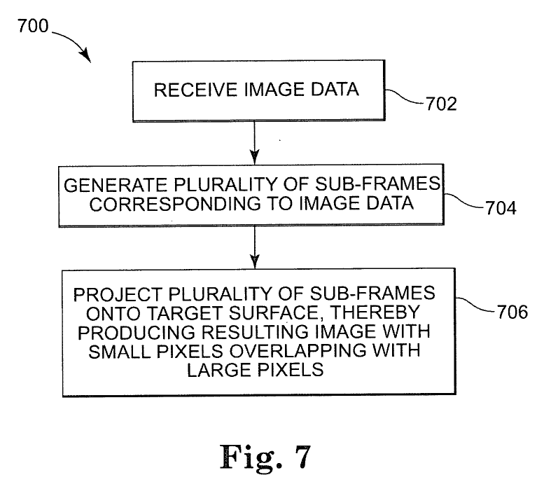

FIG. 7 is a flow diagram illustrating a method 700 of displaying an image with display system 100 (FIG. 1) according to one embodiment of the present invention. At 702, frame buffer 104 receives image data 102. At 704, sub-frame generator 108 generates a plurality of sub-frames 110 corresponding to the image data 102 based on a geometric relationship between a reference coordinate system, such as that of reference projector 118, and a plurality of projectors 112. It should be noted that, in one embodiment, the plurality of sub-frames are generated at 704 according to the techniques described above, where initial guesses for the sub-frames are determined from the high resolution image data 102 (see, e.g., Equations XI and XII and corresponding description). The plurality of sub-frames 110 are then generated from the initial guesses using an iterative process (see, e.g., Equation XV and corresponding description).

At 706, the plurality of sub-frames 110 are projected onto the target surface 116 with the plurality of projectors 112, thereby producing a resulting image 114 that includes small pixels overlapping with large pixels over a substantial portion of the resulting image 114. Embodiments for producing such an image 114 are shown in FIGS. 4-6, and described above.

One form of the present invention provides an accurate reproduction of color in the multi-projector display system 100. Given a desired high-resolution image 308 in CIE XYZ color space, sub-frame generator 108 determines the low-resolution sub-frames 110 that are to be projected from the component low-resolution projectors 112 so that the resulting image 114 is as close as possible to the original image 308 in CIE XYZ color space. In another embodiment, a linear color space other than CIE XYZ is used. It is assumed that the individual projectors 112 are color calibrated (i.e., the transforms from their device independent RGB (after gamma un-correction) to CIE XYZ space are known). These transforms may be computed by measuring the spectral power distributions of the primaries. The effects of different color characteristics of the individual projectors 112 are taken into account in the sub-frame generation process so that the color of the resulting image 114 accurately reproduces the color of the original high-resolution image 308. By taking into account color variations across multiple projectors 112, system 100 is able to provide consistent color reproduction.

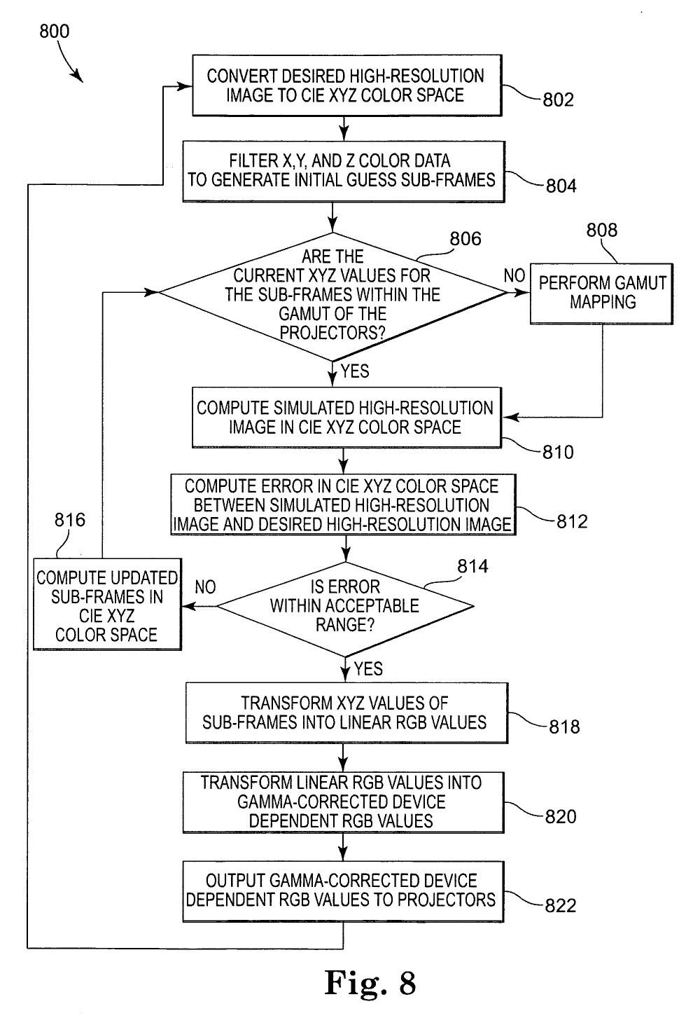

FIG. 8 is a diagram illustrating a method 800 for generating sub-frames 110 that, when projected onto target surface 116, produce an image 114 that accurately reproduces the color of a given desired high-resolution image 308 (FIG. 3), according to one embodiment of the present invention. In one embodiment, sub-frame generator 108 is configured to perform method 800.

At 802 of method 800, sub-frame generator 108 converts a given desired high-resolution image 308 from RGB color space to CIE XYZ color space. In the CIE XYZ system, Y gives luminance information, and X and Z give chrominance information. In one form of the invention, a 3×3 transformation matrix is applied on a pixel-by-pixel basis to the high-resolution image 308 to generate the CIE XYZ values at 802.

At 804, sub-frame generator 108 independently filters the X, Y, and Z color data of the image 308 to generate initial guess sub-frames 110 in the CIE XYZ color space. In one embodiment, the X, Y, and Z color data of the image 308 are separately filtered at 804 based on Equation XI or XII above.

At 806, sub-frame generator 108 determines whether the current XYZ values for the sub-frames 110 are within the gamut of projectors 112. In the first pass through block 806, the current values of the sub-frames 110 will be the XYZ values of the initial guess sub-frames 110 generated at 804. In one embodiment, the determination at 806 is made by first transforming the XYZ values of the sub-frames 110 into RGB values, and then determining if the RGB values are within the gamut of the projectors 112. If it is determined at 806 that the current values for the sub-frames 110 are within the gamut of projectors 112, the method moves to block 810. If it is determined at 806 that the current values for the sub-frames 110 are not within the gamut of projectors 112, the method moves to block 808.

At 808, sub-frame generator 108 uses a conventional gamut mapping algorithm to map the current values of the sub-frames 110 to values that fall within the gamut of projectors 112. In one embodiment of the gamut mapping at 808, the current RGB sub-frame values generated at 806 are mapped to RGB values within the gamut of projectors 112, and then these mapped RGB values are transformed back to CIE XYZ color space.

At 810, sub-frame generator 108 computes a simulated high-resolution image 306 (X-hat) in CIE XYZ color space based on the current XYZ values of the sub-frames 110. In one embodiment, the CIE XYZ values of the simulated high-resolution image 306 (X-hat) are computed at 810 based on the following Equation XVII:

$${\hat{X}}_{L} = {\sum }_{k} {F}_{k} {H}_{k} {D}^{T} \{ {L}_{k} {\sum }_{c} {T}_{c , L} {Y}_{k ; c} + {B}_{k} \} \qquad Equation XVII$$

where:
k=index for identifying the projectors 112;
L=index for identifying an X, Y, or Z value in the CIE XYZ color space;
c=index for identifying an R, G, or B value in an RGB color space;
X-hat_{L}=hypothetical or simulated high-resolution image 306 in the reference projector frame buffer 120 in the CIE XYZ color space;
Fₖ=operator that maps a low-resolution sub-frame 110 of the kth projector 112 on a hypothetical high-resolution grid to the reference projector frame buffer 120;
Hₖ=interpolating filter for low-resolution sub-frame 110 from kth projector 112;
D^{T}=up-sampling matrix;
Lₖ=spatial luminance profile of the kth projector 112;
T_{c,L}=a row of the 3×3 transformation matrix for transforming values from an RGB color space to the CIE XYZ color space;
Y_{k;c}=low-resolution sub-frame 110 of the kth projector 112 in an RGB color space; and
Bₖ=dark level of the kth projector 112.

At 812 in method 800, sub-frame generator 108 computes an error in CIE XYZ color space between the simulated high-resolution image 306 (X-hat) computed at 810 and the desired high-resolution image 308. At 814, sub-frame generator 108 determines whether the error computed at 812 is within an acceptable range. If it is determined at 814 that the error computed at 812 is outside of the acceptable range, the method 800 moves to block 816. If it is determined at 814 that the error computed at 812 is within the acceptable range, the method 800 moves to block 818.

At 816, sub-frame generator 108 computes updated sub-frames 110 in CIE XYZ color space, and the method 800 returns to block 806. In one embodiment, sub-frame generator 108 computes the updated sub-frames 110 at 816 based on the following Equation XVIII:

$${Y}_{k ; c}^{( n + 1 )} = {Y}_{k ; c}^{( n )} - Θ {\sum }_{L} {T}_{c , L}^{- 1} \{ {L}_{k}^{T} D {H}_{k}^{T} {F}_{k}^{T} ⌊ ( {\hat{X}}_{L}^{( n )} - {X}_{L}^{′} ) + {β}^{2} {∇}^{2} {\hat{X}}_{L}^{( n )} ⌋ \} \qquad Equation XVIII$$

where:
k=index for identifying the projectors 112;
n=index for identifying iterations;
L=index for identifying an X, Y, or Z value in the CIE XYZ color space;
c=index for identifying an R, G, or B value in an RGB color space;
Y_{k;c}⁽ⁿ⁺¹⁾=low-resolution sub-frame 110 for the kth projector 112 for iteration number n+1 in an RGB color space;
Y_{k;c}⁽ⁿ⁾=low-resolution sub-frame 110 for the kth projector 112 for iteration number n in an RGB color space;
Θ=momentum parameter indicating the fraction of error to be incorporated at each iteration;
T⁻¹_{c,L}=inverse of T_{c,L} in Equation XVII;
L^{T}ₖ=transpose of the spatial luminance profile, Lₖ, given in Equation XIV for the kth projector 112;
D=down-sampling matrix;
Hₖ^{T}=transpose of interpolating filter, Hₖ, from Equation XIV (in the image domain, Hₖ^{T} is a flipped version of Hₖ);
Fₖ^{T}=Transpose of operator, Fₖ, from Equation XIV (in the image domain, Fₖ^{T} is the inverse of the warp denoted by Fₖ);
X-hat_{L}⁽ⁿ⁾=hypothetical or simulated high-resolution frame 306 in the reference projector frame buffer 120 in the CIE XYZ color space, as defined in Equation XVII, for iteration number n;
X_{L}′=target profiles 312, 314, and 316 in the CIE XYZ color space;
β=smoothing constant; and
∇²=Laplacian operator.

The target profile, X_{L}′, in Equation XVIII comprises an X target profile 312 (X′_{X}), a Y target profile 314 (X′_{Y}), and a Z target profile 316 (X′_{Z}), which are shown in FIG. 3. The Y target profile 314 is also referred to as a luminance target profile, and the X and Z target profiles 312 and 316 are also collectively referred to as a chrominance target profile. The X target profile 312 is obtained by mapping CIE X values of a given desired high resolution image 308 within a range of minimum achievable CIE X values and maximum achievable CIE X values. The Y target profile 314 is obtained by mapping CIE Y values of a given desired high resolution image 308 within a range of minimum achievable CIE Y values and maximum achievable CIE Y values. The Z target profile 316 is obtained by mapping CIE Z values of a given desired high resolution image 308 within a range of minimum achievable CIE Z values and maximum achievable CIE Z values.

The minimum and maximum achievable CIE X, Y, and Z values for a given projector configuration may be obtained by using Y_{k;c}=0 and Y_{k;c}=1, respectively, in Equation XVII, and solving for X-hat_{L}. In another embodiment, the achievable CIE X, Y, and Z values for a given projector configuration may be obtained by projecting RGB sub-frames 110 onto target surface 116 with the projectors 112, capturing RGB images of the resulting image 114 with camera 122, and then converting the captured RGB images to CIE XYZ values. The minimum and maximum CIE X, Y, and Z values are the minimum and maximum values that are achievable at all points or a plurality of points on the target surface 116 for a given projector configuration.

At 818 in method 800, sub-frame generator 108 transforms the XYZ values of the sub-frames 110 into linear RGB values. At 820, sub-frame generator 108 transforms the linear RGB values of the sub-frames 110 generated at 818 into gamma-corrected device dependent RGB values. At 822, sub-frame generator 108 outputs the gamma-corrected device dependent RGB values generated at 820 to the projectors 112 for projection onto target surface 116. The method 800 then returns to block 802, and the method 800 is repeated for the next desired high-resolution image 308.

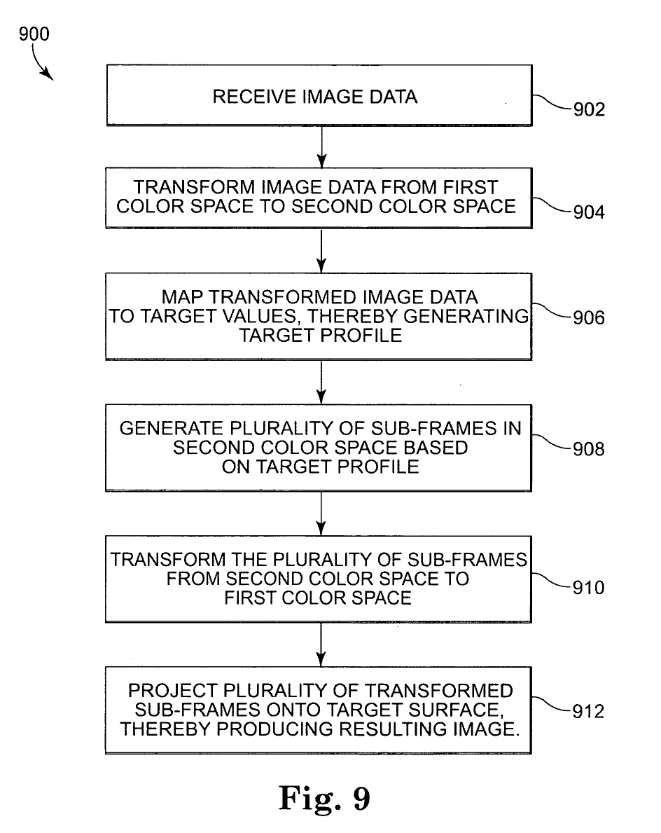

FIG. 9 is a flow diagram illustrating a method 900 of displaying an image with display system 100 (FIG. 1) according to one embodiment of the present invention. At 902, frame buffer 104 receives image data 102. At 904, sub-frame generator 108 transforms the image data 102 from a first color space (e.g., RGB) to a second color space (e.g., CIE XYZ). At 906, sub-frame generator 108 maps the transformed image data 102 to target values in the second color space, thereby generating a target profile (e.g., target profile 312, 314, and 316 in FIG. 3).

At 908, sub-frame generator 108 generates a plurality of sub-frames 110 in the second color space based on the target profile. It should be noted that, in one embodiment, the plurality of sub-frames are generated at 908 according to the techniques described above, where initial guesses for the sub-frames are determined from the high resolution image data 102 (see, e.g., Equations XI and XII and corresponding description). The plurality of sub-frames 110 are then generated from the initial guesses using an iterative process (see, e.g., Equation XVIII and corresponding description).

At 910, sub-frame generator 108 transforms the plurality of sub-frames 110 generated at 908 from the second color space to the first color space. At 912, the plurality of transformed sub-frames 110 are projected onto a target surface 116 with a plurality of projectors 112, thereby producing a resulting image 114 on the target surface 116.

One form of the present invention provides a multi-resolution multi-projector system 100 that uses a signal processing approach to optimal image display that is based on approximation theory, which is a more effective and efficient solution than the ad-hoc blending techniques that are typically used in current tiling methods. In one embodiment, the system 100 uses a coarse scale approximation and a fine scale approximation, which provide the best overall image quality for a given cost. The coarse scale approximation provides coarse details and artifact hiding, and the fine scale approximation adds fine detail.

The image formation model shown in FIG. 3 and described above is based on discrete grids. In another form of the invention, sub-frames 110 are generated by sub-frame generator 108 based on a continuous space image formation model. In continuous space, pixel shapes are represented by point spread functions, such as a spline of order 2, that can provide a better basis for approximation of a desired image 308 (X).

One form of the present invention provides an image display system 100 with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images 114 at high lumen levels, but at lower cost than existing high-resolution projection systems, such as a single, high-resolution, high-output projector. One form of the present invention provides a scalable image display system 100 that can provide virtually any desired resolution and brightness by adding any desired number of component projectors 112 to the system 100.

In some existing display systems, multiple low-resolution images are displayed with temporal and sub-pixel spatial offsets to enhance resolution. There are some important differences between these existing systems and embodiments of the present invention. For example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the invention, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the invention, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a target surface 116 that is non-planar or has surface non-uniformities. One form of the present invention generates sub-frames 110 based on a geometric relationship between a hypothetical high-resolution reference projector 118 at any arbitrary location and each of the actual low-resolution projectors 112, which may also be positioned at any arbitrary location.

In one embodiment, image display system 100 is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays. For example, for a displayed image 114 with a plurality of tiles, each tile in the displayed image 114 could be produced by a different plurality of overlapping projectors 112, such as a first set of three projectors 112 for producing overlapping sub-frames for a first tile, a second set of three projectors 112 for producing overlapping sub-frames for a second tile, and so on.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of displaying an image with a display system, the method comprising:
receiving image data for the image;
generating a plurality of sub-frames corresponding to the image data based on a geometric relationship between a reference coordinate system and a plurality of projectors;
projecting the plurality of sub-frames onto a target surface with the plurality of projectors, thereby producing a resulting image on the target surface; and
wherein the resulting image includes small pixels overlapping with large pixels over a substantial portion of the resulting image.

2. The method of claim 1, wherein first and second ones of the projectors each include an imaging array with pixels of varying sizes.

3. The method of claim 2, wherein the first and the second projectors are configured to project sub-frames such that small pixels produced by the first projector substantially overlap large pixels produced by the second projector, and large pixels produced by the first projector substantially overlap small pixels produced by the second projector.

4. The method of claim 1, wherein first and second ones of the projectors each include optics to distort projected sub-frames and thereby produce pixels of varying sizes in the projected sub-frames.

5. The method of claim 4, wherein the first and the second projectors are configured to project sub-frames such that small pixels produced by the first projector substantially overlap large pixels produced by the second projector, and large pixels produced by the first projector substantially overlap small pixels produced by the second projector.

6. The method of claim 1, wherein a first and a second one of the projected sub-frames are tiled sub-frames, and a third one of the projected sub-frames substantially overlaps both the first and the second projected sub-frames on the target surface.

7. The method of claim 6, wherein a fourth one of the projected sub-frames substantially overlaps the first, the second, and the third projected sub-frames.

8. The method of claim 6, wherein the third projected sub-frame is substantially larger than the first and the second projected sub-frames, and wherein the third projected sub-frame has substantially larger pixels than pixels of the first and the second projected sub-frames.

9. The method of claim 1, and further comprising:
determining minimum and maximum achievable luminance levels at a plurality of points on the target surface.

10. The method of claim 9, and further comprising:
mapping luminance values of the image data to target luminance values that are within the minimum and maximum achievable luminance levels, thereby generating a target luminance profile.

11. The method of claim 10, wherein the plurality of sub-frames are generated based on a difference between a simulated image and the target luminance profile.

12. The method of claim 11, wherein the simulated image is defined as a summation of up-sampled, filtered, and geometrically transformed sub-frames.

13. A system for displaying an image, the system comprising:
a plurality of projection devices;
a buffer adapted to receive image data for the image;
a sub-frame generator configured to define a plurality of sub-frames corresponding to the image data based on a geometric relationship between a reference coordinate system and the plurality of projection devices; and
wherein the plurality of projection devices are adapted to project the plurality of sub-frames onto a target surface, thereby producing a resulting image on the target surface, the resulting image including high resolution pixels overlapping with low resolution pixels over a substantial portion of the resulting image.

14. A method of displaying an image with a display system, the method comprising:
receiving image data for the image;
transforming the image data from a first color space to a second color space;
mapping the transformed image data to target values in the second color space, thereby generating a target profile;
generating a plurality of sub-frames in the second color space based on the target profile;
transforming the plurality of sub-frames from the second color space to the first color space; and
projecting the transformed sub-frames onto a target surface with a plurality of projectors, thereby producing a resulting image on the target surface.

15. The method of claim 14, and further comprising:
determining minimum and maximum achievable luminance values and chrominance values at a plurality of points on the target surface; and
wherein the target values include target luminance values that are within the minimum and maximum achievable luminance values, and wherein the target values include target chrominance values that are within the minimum and maximum achievable chrominance values.

16. The method of claim 14, wherein the first color space is RGB, and the second color space is CIE XYZ.

17. The method of claim 16, and further comprising:
determining minimum and maximum achievable X, Y, and Z values in the CIE XYZ color space at a plurality of points on the target surface.

18. The method of claim 17, wherein the target values are X, Y, and Z values in the CIE XYZ color space that fall within the minimum and maximum achievable X, Y, and Z values, respectively.

19. The method of claim 14, wherein the plurality of sub-frames are generated based on a difference between a simulated image and the target profile.

20. The method of claim 19, wherein the simulated image is defined as a summation of up-sampled, filtered, and geometrically transformed sub-frames.
